(19) United States
(12) Patent Application Publication
(10) Pub. No.: US 2024/0165531 A1
(43) Pub. Date: May 23, 2024

(54) MOTION ACTIVATED SOUND EFFECTS GENERATING DEVICE

(71) Applicant: MORF, LLC, Los Angeles, CA (US)

(72) Inventor: Eitan Kramer, Los Angeles, CA (US)

(21) Appl. No.: 17/993,807

(22) Filed: Nov. 23, 2022

Related U.S. Application Data
(60) Provisional application No. 63/282,972, filed on Nov. 24, 2021.

(51) Int. Cl. A63H 33/26; A63H 5/00

(52) U.S. Cl. CPC A63H 33/26; A63H 5/00

(57) ABSTRACT

A motion-activated sound generating device configured to be held in a hand of a user. The device includes a motion sensing system configured to sense a motion and/or movement of the device by the user, the motion sensor providing a motion signal representing the sensed motion. The device further includes a processor provided with the housing and connected with the motion sensing system, the processor being configured to receive the motion signal, map the motion signal to one of a plurality of predefined motions of the device, and generate an output action based on the mapped one of the plurality of predefined motions, the output action being one or more of an audio and/or video output signal. The device further includes an output device provided with the housing and configured for outputting the one or more of the audio and/or video output signal.

### CROSS-REFERENCE TO RELATED APPLICATIONS

The present application claims priority of U.S. Provisional Application No. 63/282,972, filed Nov. 24, 2021, and entitled “MOTION ACTIVATED SOUND EFFECTS GENERATING DEVICE”, the entirety of which is incorporated by reference herein.

### BACKGROUND

People, particularly young people, have a need for a device that generates sounds by their movement. Such a device can provide entertainment, as well as assist with physical fitness, mental acuity, rhythm development, coordination and balance, musicality development, and the like.

### SUMMARY

This document presents a novel motion-activated sound generating device. The device includes a memory that stores sounds and/or lighting patterns, and a processor that receives input from user-activated controls or sensors that sense movement of the device, to control various aspects of the device. The device can generate music, such as drum beats, musical notes or a series of notes, or other sound effects, based on a user's movement and/or motion of the sound generating device, as well as user manipulation of one or more control buttons on the device. The combination of manipulation of control buttons and movement of the device can produce limitless combinations of sound and lights.

In some aspects, a motion-activated sound generating device configured to be held in a hand of a user is presented. The device includes a motion sensing system configured to sense a motion and/or movement of the device by the user, the motion sensor providing a motion signal representing the sensed motion. The device further includes a processor provided with the housing and connected with the motion sensing system, the processor being configured to receive the motion signal, map the motion signal to one of a plurality of predefined motions of the device, and generate an output action based on the mapped one of the plurality of predefined motions, the output action being one or more of an audio and/or video output signal. The device further includes an output device provided with the housing and configured for outputting the one or more of the audio and/or video output signal

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1A and 1B are block diagrams of a motion-activated, sound effects-generating device, and a coordinate system in which motion of the device can take place, respectively;

FIGS. 2A-2C are a perspective view, a top-down view, and a bottom-up view, respectively, of a motion activated sound generating device in accordance with implementations of the subject matter described herein;

FIG. 3A shows an example skin that can be applied on the device, and FIG. 3B illustrates the device with the skin and having one or more lights that can be controlled by a user via control buttons or movement of the device in general; and

FIGS. 4A-4D are a left-side view, a right-side view, a top-down view, and a bottom-up view of a motion-activated, sound effects-generating device in accordance with alternative implementations; and

FIG. 5 illustrates the device as embodied as a smart phone but with an application (“app”) that registers movement sensed by an integrated sensor, and produces outputs as generally described herein.

Like reference symbols in the various drawings indicate like elements.

### DETAILED DESCRIPTION

This document describes a motion-activated sound generating device. The device includes a memory that stores a library of sounds and/or lighting patterns, and a processor that receives input from user-activated controls or sensors that sense movement of the device, to control various aspects of the device. The device can generate music, such as drum beats, musical notes or a series of notes, sound effects such as gun blasts and sword “swooshes,” animal sounds such as a dog's bark or a cow's “moo,” or any other sounds based on a user's movement and/or motion of the sound generating device.

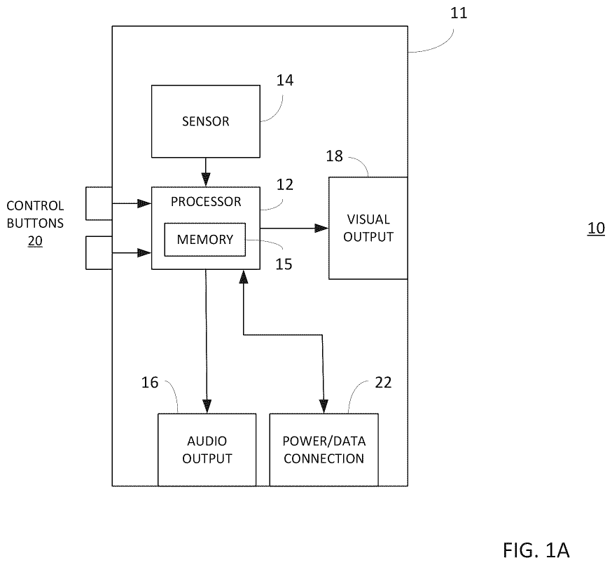

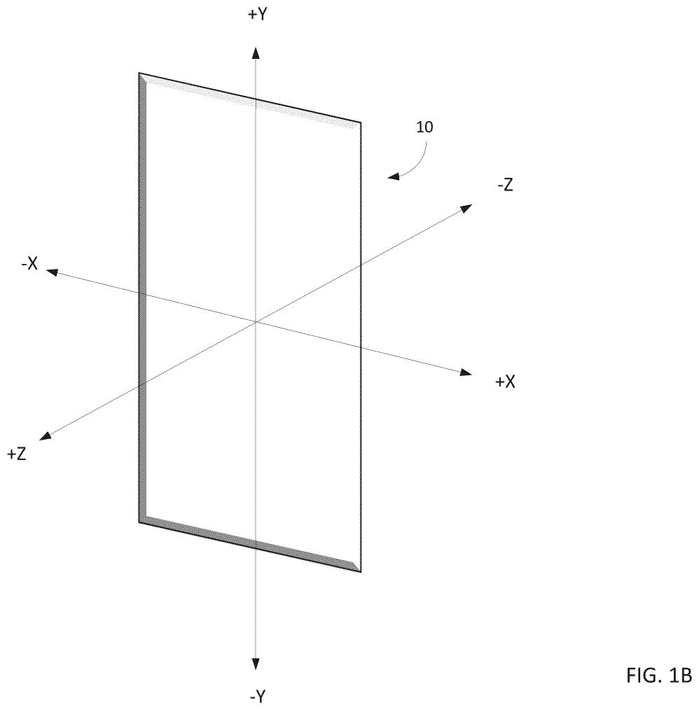

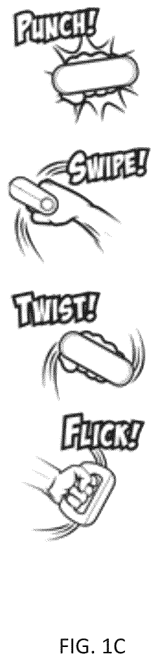

In some implementations consistent with the subject matter described herein, and as illustrated in FIG. 1A, a device 10 includes a housing 11. The housing 11 can have any form factor or shape, but is preferably of a form to be held in or gripped by a user's hand. For instance, as shown and described below, the device 10 and housing 11 can be an O-shape, where a portion of the shape provides a “pistol” grip by which the user can curl four fingers around a grip region while allowing their thumb to be free to manipulate one or more control buttons 20. Alternatively, the control buttons 20 can be positioned for access and control by any of the other fingers of the user. The housing 11 can be formed of a rigid material such as plastic, nylon, metal, or the like.

The device 10 further includes a processor 12 that receives motion or movement information of the device 10 by the user from sensor 14. The sensor 14 can be any type of motion sensor, such as an accelerometer, a gyroscope, and/or a speed sensor. The sensor can also include a temperature sensor, a proximity sensor, a heartrate sensor, or other bodily sensor or monitor such as a pulse oximeter or the like. The sensor can also be a geographical position sensor, such as a Global Positioning System (GPS) sensor.

The processor 12 receives input from the sensor 14, as well as user input from one or more control buttons 20, to execute a set of instructions to produce one or more outputs. The control buttons 20 can be physical, spring-loaded buttons, touch sensitive regions of the housing 11, or other types of user-activatable inputs. The one or more outputs can be audio generated by the processor 12 and sent to audio output 16, such as a loudspeaker or headphone jack. The audio output 16 can also include an external speaker or external electronic device, such as a mobile phone, laptop computer, desktop computer, music player, etc., and which one or more of the external devices are connected to the device 10, either by a wired connection or via wireless interface (WiFi, Bluetooth, etc.).

The one or more outputs can also be visual, as generated by the processor 12 and sent to visual output 18, such as a light-emitting diode (LED) output, video screen, or other visual display. The audio and visual outputs 16, 18 can be coordinated or mapped to each other by the processor 12, or either or both can be randomly generated. Preferably, however, the audio and visual outputs 16, 18 output audio or visual signals that are generated by the processor 12 based on one or more predetermined movements of the device 10 as detected, interpreted, or discerned by the sensor 14. The visual output 18 can also be an output to an external display or visual device, such as a graphics display, mobile phone, computer, or television, as but just some examples, and connection to these external display devices can be by wired (USB, HDMI, DVI, VGA, etc.).

The device 10 can further include a power/data connection 22 or port(s), such as a Universal Serial Bus (USB) port or the like, for charging the device and/or uploading and/or downloading data to/from a memory 15 connected with the processor 12. The power/data connection 22 can also include a transceiver for wireless communications, such as WiFi, Bluetooth, cellular, or the like. The power/data connection 22 can be one or multiple ports, in case charging the device 10 needs to be separated from uploading and/or downloading of audio files created by the user. The power/data connection 22 can also include an audio jack into which headphones and/or external speakers can be plugged. The device 10 can further include a microphone, for recording sounds made by the user or in near proximity to the device 10.

The memory 15 can store, for example, pre-recorded soundtracks, and/or audio signals produced by a user moving the device 10 in a predetermined manner, as further explained below. The processor 12 can be programmed to mix, mash or otherwise combine pre-recorded sounds with user-generated sounds to produce any number of discrete audio files. These audio files can be played back, either through the device 10 or through an external device such as a speaker or computer, via the power/data connection 22.

As described above, the device 10 is configured to generate sound and/or visual signals, based on one or more user-induced motions of the device 10. The motions are preferably pre-programmed and mapped to movements within a three-dimensional planar coordinate system such as shown in FIG. 1B. For instance, the movements can be mapped to any combination of movements along or within the X, Y and Z coordinates of a three-dimensional coordinate system.

For example, and as shown in FIG. 1C, the motions employed by a user or holder of the device 10, and by which the device is pre-programmed to interpret and discern a motion or movement to produce a particular mapped sound, can include, without limitation, a “punch” such as punching forward and backward through a frontal axis of the device (i.e. back and forth along the X axis shown in FIG. 1B), a “swipe” or moving up, down, left, and right (i.e. transitioning from one axis to another), a “twist” or rotation about a central vertical axis of the device 10, a “flick” characterized by a rapid transition from one axis to another, and any combination thereof. Other motions or combinations of movements can be used and interpreted by the device to generate specific sounds that are preprogrammed and mapped to those motions.

Each of the above movements or motions of the device can also be used based on a degree or extent of the movement or motion. For instance, a “punch” can be a short punch movement to produce one sound, while a longer “punch” can produce a second, different sound. In some implementations, the device can be programmed to discern or recognize a range for each basic movement, to produce two or more sounds according to the range.

In some implementations, the device can be configured to only register movements, or map such movements to a sound generation, if the movement meets a threshold of time or duration. Accordingly, movements that exceed the threshold will not be registered or interpreted, which will allow a user to move around with the device and not trigger some kind of response. The visual output can be coordinated with the audio output so that the user can better determine what movements are being registered. For example, each predetermined movement can be color-coded and mapped to a visual output: “punch” is associated with a red LED; “swipe” is associated with a green LED; “flick” is associated with a blue LED; and “twist” is associated with a yellow LED. Of course, those of skill in the art would recognize that any color or other visual output can be associated with any of the predetermined movements or motions of the device by the user.

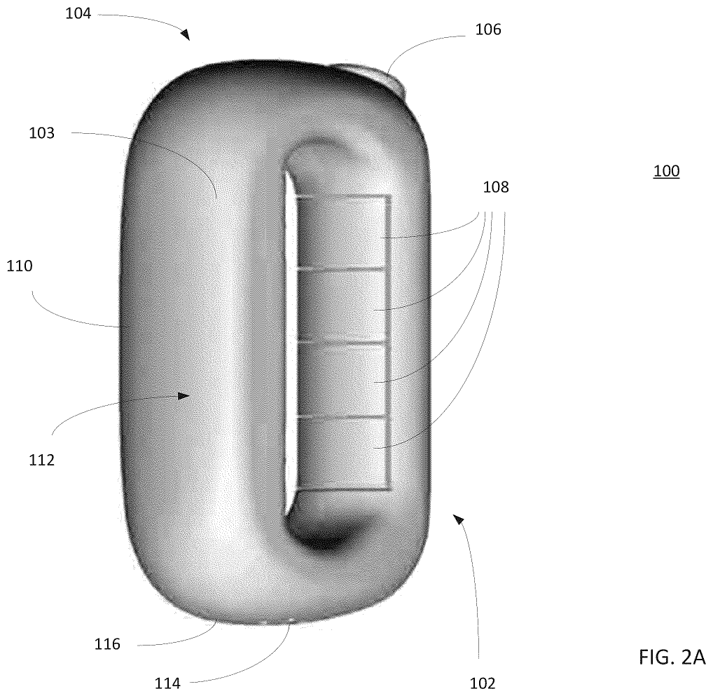

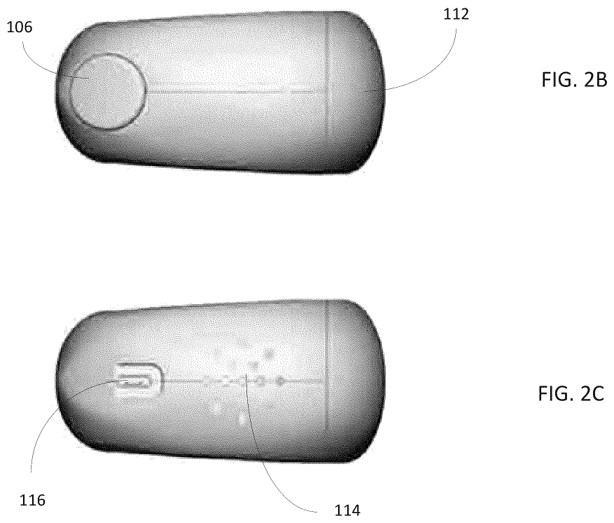

FIGS. 2A, 2B, and 2C are a perspective view, a top-down view, and a bottom-up view, respectively, of a motion activated sound generating device 100 in accordance with implementations of the subject matter described herein. The device 100 includes a housing 103, which is preferably implemented as an O-shaped housing, but which can also be U-shaped or V-shaped (either right-side up or upside down), or other shape that can be easily gripped and manipulated by at least one had of a user. For instance, the housing 103 can be in the shape of a mobile phone or be a part of a mobile phone.

In some implementations, the housing 103 includes a handgrip portion 102 and an outer portion 104 opposite the handgrip portion 102. The handgrip portion 102 is sized and configured to be gripped and held by a hand of the user, or at least by one or more fingers of the user's hand. The housing 103 can be formed of a rigid or semi-rigid material, such as plastic, nylon, carbon fiber, metal, glass, or the like, or in any combination thereof. In alternative implementations, the device 100 can be formed as a U-shaped member, either right-side up or upside down.

In alternative implementations, and as described in further detail below, the device 100 can be a mobile phone, smartphone or other electronic device that can run or execute an application, where the application can provide a graphical representation of control buttons and switches, perform the functions described herein in software.

The handgrip portion 102 can include a master control button 106. The master control button 106 can be positioned on the top of the device 100, to be accessible to the user's thumb when the user grips the handgrip portion 102. In preferred implementations, the master control button 106 can be a depressible button, a turnable or rotatable knob, or a pivoting or movable switch that can be pivoted or moved in multiple directions. Whichever way the master control button 106 is manipulated by the user, it is configured to allow the user to cycle through and play different sounds or music stored on the device 100 in a memory, such as background music or drumbeat, for example, or can be controlled to record sounds by the user or in proximity to the device 100.

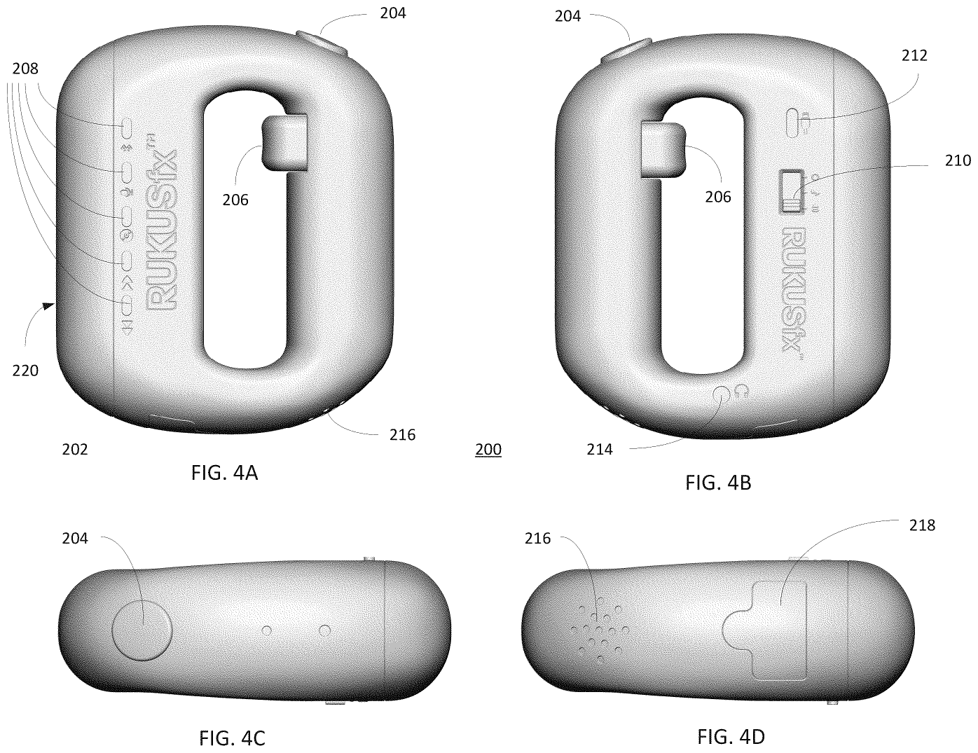

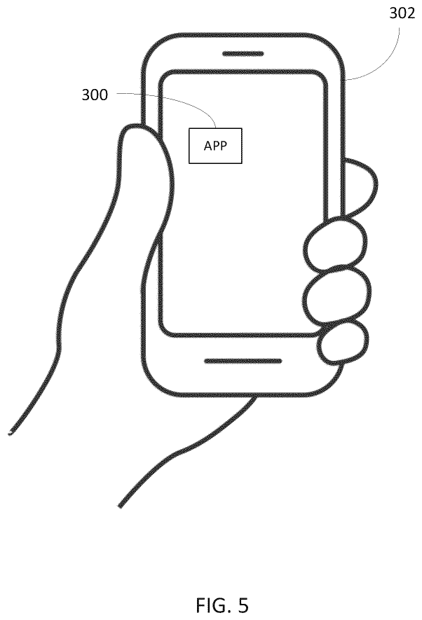

The housing 103, such as the handgrip portion 102 of the device 100, can further include one or more secondary control buttons 108, which are positioned to be accessible by one or more of the user's fingers, i.e., on an inside surface of the handgrip portion 102 or on an outer surface of the housing, as shown in FIGS. 4A-4D. In some preferred implementations, the device 100 includes four secondary control buttons 108 on an inner surface of the O-shaped housing, which can be sized and positioned for access and operation by a corresponding one of a user's four fingers.

The secondary control buttons 108 can be physically depressible, such as spring-activated, or can be pressure-sensitive regions, with or without a haptic response or feedback. The secondary control buttons 108 can be used to control an audio and/or visual output of the device 100 according to the various pre-programmed motions of the device 100 by a user. One or more of the secondary control buttons 108 can be accessed and manipulated at the same time for added control functionality.

In some preferred exemplary implementations, the secondary control buttons 108 include a first button, which can be activatable by a user's finger, and which enables a user to record a song or sound effects that are produced when moving the device. A second button enables a user to manipulate a microphone, which can be built into housing of the device. In some implementations, a third button allows a user to cycle forward in the memory through music or sound effects options, and a fourth finger button lets the user cycle backward through music or sound effects options.

In some implementations, as a user can cycle forward or backward through different music or sound effect options, and the device will play a short clip of each song or sound effect depending on a mode selected by the user. Once a user hears music or a sound effect that they like, they can start to augment with motion-based sound production by moving the device. As the user cycles forward or backward through the music or sound effects library, the device can generate a visual output. For instance, the visual output can include one or more LEDs that that can be programmed to turn on or off based on how the user is scrolling through the library.

For example, in some implementations, a first color light, i.e., a blue light, can indicate a “performance record” mode (sound generation and recording based on motion of the device), whereas a second color light, i.e., a red light, can indicate a “microphone record” mode (sound recording from the user entering sounds into the microphone). Regardless of how the sounds are generated in either mode, the user needs only to move the device to start playing the recorded sounds in a playback mode.

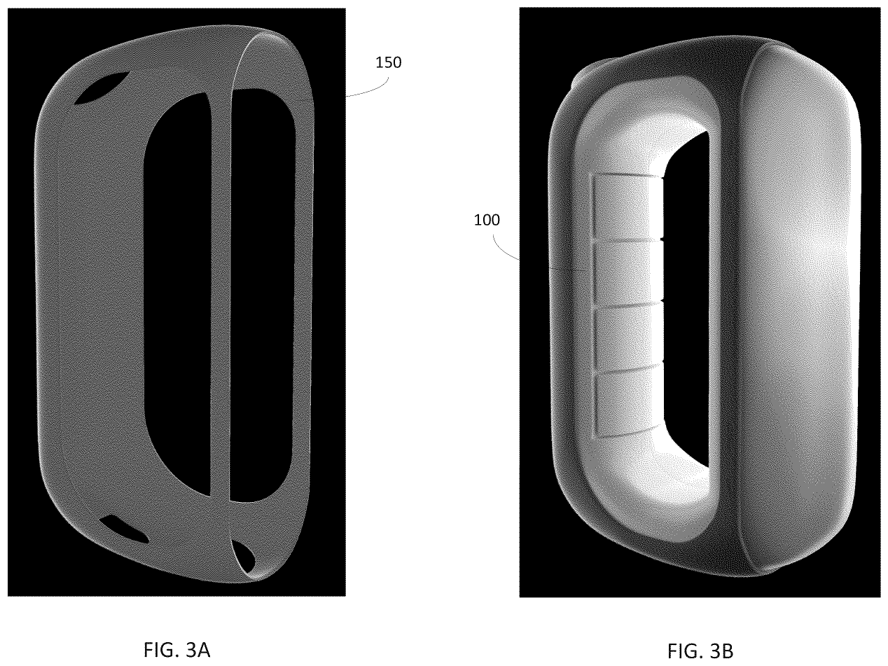

The outer portion 104 can include a light-up section 110, which is also illustrated in FIG. 3. The light-up section 110 can include one or more lights, such as a tri-color light emitting diode (LED) array, which can be controlled either by manipulation of the master control button 106, the secondary control buttons 108, and/or movement of the device 100. The outer portion 104 can also house or include one or more sensors 112, including, without limitation, a motion sensor, accelerometer, gyroscope, speed sensor, temperature sensor, proximity sensor, heartrate sensor or monitor, or the like, as well as a battery or other power source. The sensors 112 can interpret movement, motion, or other manipulation of the device 100 to control the sounds produced by the device 100 or the lighting produced by the device. The sensors 112 can be programmed to cooperate with the master control button 106 and/or the secondary control buttons 108 to produce any number of sounds and/or lighting, and any combinations thereof.

The O-shaped housing can further include a speaker 114 and a power and/or data connection port 116. For instance, the power/data connection port 116 can be a micro universal serial bus (USB) port for the transfer of data and/or programming instructions. The power and/or data connection port 116 can be used to connect two devices together for coordinated sound and light generation. The device 100 can also include one or more haptic feedback devices, such as a vibrator or other physically pulsing device.

In some implementations, the device 100 can include a wireless transceiver for pairing with an external communication device, such as one or more other devices 100. In these implementations, multiple devices 100 can communicate signals between themselves for coordinated sound and light generating functionality. For instance, two users, each using one device 100, can have a “sword fight” with sounds that represent connection and clashing of imaginary blades. Other coordinated communications are possible, such as a boxing match between two users each clutching two devices 100, one in each hand. Further still, the device 100 can be used in conjunction with a software application, such as on a mobile device.

FIGS. 3A and 3B illustrate a skin 150 that can be provided over the device 100, for protection of the device 100 and/or to allow a user to give the device 100 a unique look and/or feel. The skin 150 can also be shaped and configured to fit over a mobile phone when the subject matter described herein is implemented as an application that can be executed by the mobile phone, and which can improve a user's hand grip on the mobile phone.

FIGS. 4A-4D are a left side view, a right-side view, a top-down view, and a bottom-up view of a motion-activated, sound effects-generating device 200 in accordance with alternative implementations of the subject matter described herein. The device 200 includes a housing 202, and a first primary control button 204 and a second primary control button 206. The housing 202 is shaped and configured to as to allow a user to grip the device 200 with one hand, and the first and second primary control buttons 204, 206 are positioned on the housing 202 to be accessible by a user's thumb and index finger, respectively.

The first primary control button 204 and/or second primary control button 206 can be configured to control functions such as, without limitation, record a sound, switch to different sounds to make with the device based on a movement or motion of the device 200, generate a visual output, generate an audio output, or the like. The first primary control button 204 and the second primary control button 206 can be used independently or in concert with each other for providing a number of additional functions by the device 200.

The device includes one or more secondary control buttons 208, which can include, without limitation, a wireless (i.e., Bluetooth) pairing control, a microphone control, a record button, a skip forward button, and a rewind button. These one or more secondary control buttons 208 can further include a volume UP, volume DOWN, audio MUTE, or other functions.

As shown in FIG. 4B, the device 200 can further include a power/data port 212 for connecting the device 200 to a power source, or to a data connection. The device 200 can further includes an audio jack for connecting to an external audio source, such as headphones, one or more speakers, a stereo system, an external computer, a television, or the like.

In some implementations, the device 200 includes one or more built-in loudspeakers 216 for real-time generation of sounds based on movements or motions by the user of the device 200. The device 200 can also include a battery or charging port 218, for receiving one or more batteries or for connecting to an external power source.

When the device is ON but not in use, it can be programmed go to “sleep” to save power. To wake the device up, a user just presses any of the input control buttons, and/or perform any of the predetermined basic movements. The device can be configured to reset to the beginning of the music or sound effects library just as when powered it on initially.

Although a few embodiments have been described in detail above, other modifications are possible. Other embodiments may be within the scope of the following claims.

1. A motion-activated sound generating device configured to be held in a hand of a user, the device comprising:
a housing sized and configured to be held in the hand of the user;
a motion sensing system provided with the housing and configured to sense a motion of the device by the user, the motion sensor providing a motion signal representing the sensed motion;
a processor provided with the housing and connected with the motion sensing system, the processor being configured to receive the motion signal, map the motion signal to one of a plurality of predefined motions of the device, and generate a predetermined output action based on the mapped one of the plurality of predefined motions, the output action being one or more of an audio and/or video output signal; and
an output device provided with the housing and configured for outputting the one or more of the audio and/or video output signal.

2. The device in accordance with claim 1, wherein the output device is a speaker, and the output action is an audio signal configured to be output from the speaker.

3. The device in accordance with claim 1, wherein the output device includes one or more lights, and the output action is a light-activation signal configured to operate the one or more lights.

4. The device in accordance with claim 1, wherein the housing is formed with a handgrip portion configured to be held by the hand of the user.

5. The device in accordance with claim 1, wherein the motion sensing system includes an accelerometer.

6. The device in accordance with claim 5, wherein the accelerometer is configured to sense each of a set of pre-determined motions of the device by the user.

7. The device in accordance with claim 1, wherein the motion sensing system includes a gyroscope.

8. A motion-activated sound generating device configured to be held in a hand of a user, the device comprising:
a motion sensing system configured to sense a motion and/or movement of the device by the user, the motion sensor providing a motion signal representing the sensed motion;
a processor provided with the housing and connected with the motion sensing system, the processor being configured to receive the motion signal, map the motion signal to one of a plurality of predefined motions of the device, and generate an output action based on the mapped one of the plurality of predefined motions, the output action being one or more of an audio and/or video output signal; and
an output device provided with the housing and configured for outputting the one or more of the audio and/or video output signal.

9. The device in accordance with claim 8, further comprising a housing sized and configured to be held in the hand of the user, the housing containing the motion sensing system, the processor, and the output device.

10. The device in accordance with claim 8, wherein the motion sensing system comprises an accelerometer and a gyroscope.

11. The device in accordance with claim 9, wherein the housing is formed with a handgrip portion configured to be held by the hand of the user.

12. The device in accordance with claim 8, wherein the output device is a speaker, and the output action is an audio signal configured to be output from the speaker.

13. The device in accordance with claim 8, wherein the output device includes one or more lights, and the output action is a light-activation signal configured to operate the one or more lights.

14. The device in accordance with claim 8, wherein the output device includes a wireless connection to an external loudspeaker.
